(19) United States
(12) Patent Application Publication
(10) Pub. No.: US 2008/0055066 A1
(43) Pub. Date: Mar. 6, 2008

(54) Method and apparatus for actuating vehicle headlights simultaneously with vehicle horn to provide both visual and audible alert system

(76) Inventor: Patrick Daniel Griffin, Newark, DE (US)

Correspondence Address: PATRICK D. GRIFFIN, 103 TANGLEWOOD LANE, NEWARK, DE, 19711, US

(21) Appl. No.: 11/511,067

(22) Filed: Aug. 28, 2006

(51) Int. Cl. B60Q 5/00

(52) U.S. Cl. 340/474

(57) ABSTRACT

The present invention relates to vehicle systems for alerting operators of other vehicles, pedestrians, or passerby regarding vehicle position relative to other vehicles, and more particularly a method and apparatus for simultaneously activating both the vehicle headlights and horn when the vehicle horn is activated by the driver to alert the operator of another vehicle, a pedestrian, or passerby regarding the first vehicle's position.

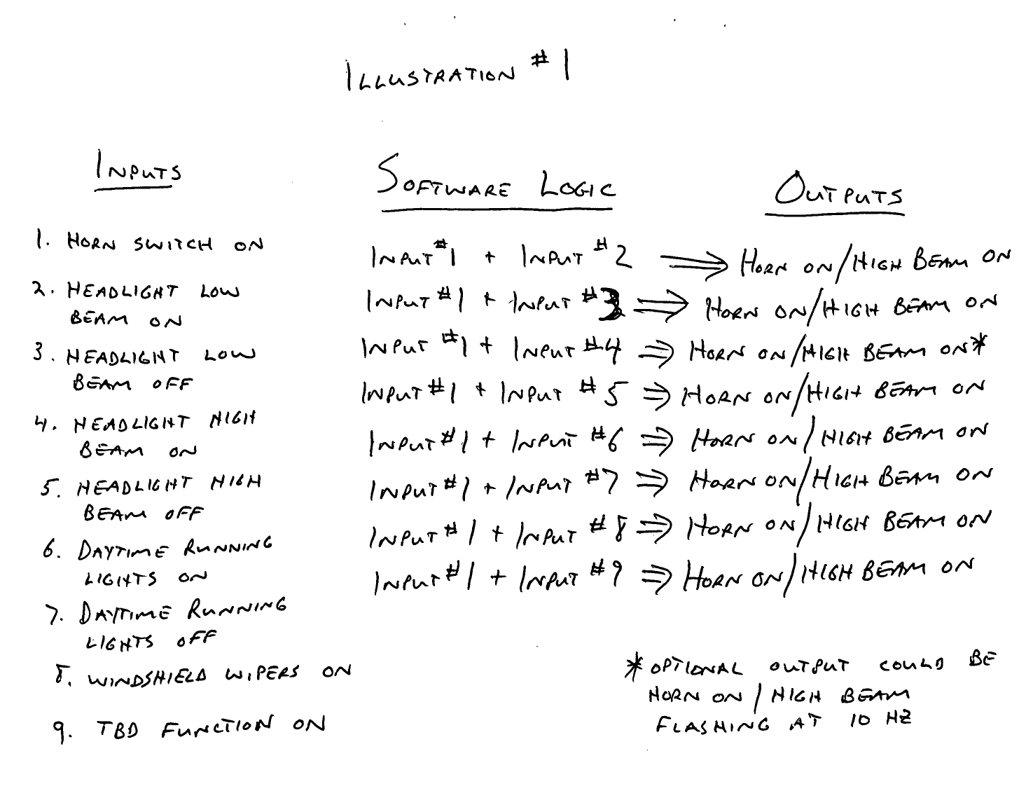

### CROSS REFERENCE TO RELEATED APPLICATIONS

not applicable

### FEDERALLY SPONSORED RESEARCH

not applicable

### SEQUENCE LISTING OR PROGRAM

not applicable

### BACKGROUND OF THE INVENTION

The present invention relates to vehicle systems for alerting other drivers regarding vehicle position relative to other vehicles, and more particularly a method and apparatus for simultaneously activating both the vehicle headlights and horn when the vehicle horn is activated by the driver to alert the operator of another vehicle, a pedestrian, or passerby regarding the first vehicle's position.

Nearly all vehicles since very early times have included an audible device (horn) for the purpose of allowing others in the near vicinity to be alerted to its approach, position relative to the others, and for other reasons related to safety and awareness. Additionally since very early times, vehicles have been equipped with headlights for the purpose of improving night time driving visibility for the driver, and providing increased visibility of the first vehicle to others. At present time however, there are no vehicle applications where the horn actuator and headlight actuator are simultaneously activated by a single actuator operated by the driver for the purpose of alerting others of the first driver's vehicle position. It is common practice for a driver of a first vehicle to alert others of his position by actuating the horn on the first driver's vehicle. It is also common practice for a driver of a first vehicle to alert the driver of a vehicle in front that a passing maneuver will be executed. This feature is commonly described in a vehicle operators manual as “flash to pass” and is often activated by a switch in the headlight high beam/ low beam switch. Additionally it has been demonstrated that Day Time Running Lights (lower powered vehicle headlights) provide a measurable improvement to the visibility of a vehicle by other vehicle operators. There are other examples possible where lighting is used to increase the visibility of one vehicle to the operator of another vehicle or others in the surrounding area. The present invention will describe a method and apparatus for providing a simultaneous audible and visual alert system when the driver of a first vehicle desires to alert others regarding the position of the first vehicle.

In modern vehicles it is common practice to incorporate an electronic module to control various vehicle functions. For example the engine control module receives multiple input signals from sensors measuring the driver's input (throttle position, engine ignition switch position, . . . ), engine parameters (engine load, exhaust gas air to fuel ratio, engine coolant temperature, engine inlet air temperature, engine RPM, . . . ) to control the various actuators on the engine (fuel injector pulse width, ignition timing, . . . ). Similarly electronic control modules are used for the anti-lock brake systems, traction control system, and vehicle speed control system to name a few other examples. The present invention includes both the method and apparatus to link the headlight actuation and horn actuation for the purpose of alerting other drivers of a first vehicle's position. Illustration 1 provides an example of a flow chart describing the various input signals from various sensors and switches, an electronic control module to receive these inputs and calculate the desired output signal, and output drivers to activate the headlights and horn simultaneously when desired.

### PRIOR ART

none.

### OBJECTS AND ADVANTAGES

The primary advantage of this invention is the combined function of light and sound to alert another driver, pedestrian, or any other person or animal of your position. In automotive applications where fractions of a second related to distance traveled and human reaction time are involved, the near instantaneous benefit of a visual alert/warning device in addition to an audible alert/warning device can make the difference between an accident and a near miss.

### SUMMARY

The present invention provides the function of a dual simultaneous alert system that includes both sound and light to alert other drivers, pedestrians, or anyone within audible range or line of sight to be warned of the position of a first vehicle. In summary, when the driver of a first vehicle actuates the horn, the headlight high beam will also be actuated simultaneously to provide a secondary and near instantaneous alert signal. The dual warning/alert signals of sound and light will be actuated based on the driver actuating the horn switch and a pre-programmed electronic module monitoring other vehicle lighting input signals along with various other input signals. The electronic module will then simultaneously provide an output signal to actuate both the headlight high beam and horn actuator.

### DRAWINGS

See Illustration #1.

### DETAILED DESCRIPTION

The present invention described in this patent application relates to an alert system on a vehicle that provides both an audible and visual warning signals to other drivers, pedestrians, passerby, and animals (all of these referred to as others). In a preferred embodiment, when the driver of a first vehicle actuates the audible horn switch, this signal will be sent to an onboard electronic module with preprogrammed logic. The driver commanded horn signal along with other vehicle lighting system input signals and other vehicle system signals, will be processed by the preprogrammed electronic module. Based on these inputs, the electronic module will provide an output signal commanding both the horn actuator and headlight high beams simultaneously. When the driver actuates the horn switch and the headlight low beam is on, then the electronic module will provide an output signal to command both the horn actuator and headlight high beam simultaneously. When the driver actuates the horn switch and the headlight low beam is off, then the electronic module will provide an output signal to command both the horn actuator and headlight high beam simultaneously. When the driver actuates the horn switch and the headlight high beam is on, then the electronic module will provide an output signal to command both the horn actuator and headlight high beam simultaneously. When the driver actuates the horn switch and the headlight high beam is off, then the electronic module will provide an output signal to command both the horn actuator and headlight high beam simultaneously. When the driver actuates the horn switch and the headlight Daytime Running Lights are on, then the electronic module will provide an output signal to command both the horn actuator and headlight high beam simultaneously. When the driver actuates the horn switch and the Daytime Running Lights are off, then the electronic module will provide an output signal to command both the horn actuator and headlight high beam simultaneously. When the driver actuates the horn switch and the headlight windshield wipers are on, then the electronic module will provide an output signal to command both the horn actuator and headlight high beam simultaneously. When the driver actuates the horn switch and a to be determined function are on, then the electronic module will provide an output signal to command both the horn actuator and headlight high beam simultaneously. The to be determined function could be related to the vehicle stability system activated, the traction control system activated, any other safety system activated, or a new function related to safety not already mentioned here.

### Description—Additional Embodiment

In an alternate embodiment, the present invention could be a mechanical/analog system where when the driver actuates the horn switch, a mechanical relay provides a higher power voltage signal to both the horn actuator and the head light high beam. Multiple relays could be incorporated to mechanically duplicate the logic presented above with analog devices.

### Conclusion

In conclusion, the present invention combines the function of light and sound to alert another driver, pedestrian, or any other person or animal of your position. In automotive applications where fractions of a second related to distance traveled and human reaction time are involved, the near instantaneous benefit of a visual alert/warning device in addition to an audible alert/warning device can make the difference between an accident and a near miss.

I claim:

1. A method whereby an electronic control module with preprogrammed logic receives input signals from various vehicle functions specifically including the audible horn actuator switch controlled by the driver, processes these inputs, and then provides an output command to actuate both the horn actuator and headlight high beams simultaneously.

2. A method whereby an electronic control module with preprogrammed logic receives input signals from various vehicle functions specifically including the audible horn actuator switch controlled by the driver, processes these inputs, and then provides an output command to actuate both the horn actuator and flashes the headlight high beams at 10 Hz (or a similar frequency that provides an alternately effective warning/alert signal) simultaneously.

3. A method whereby a mechanical/electrical relay system receives voltage signals from various vehicle functions specifically including the audible horn actuator switch controlled by the driver, and then provides an output voltage of higher power to actuate both the horn actuator and headlight high beams simultaneously.
